(19) United States
(12) Patent Application Publication
(10) Pub. No.: US 2011/0141844 A1
(43) Pub. Date: Jun. 16, 2011

(54) STATIC MIXER

(75) Inventor: Andreas SCHELL, Issing (DE)

(73) Assignee: Hilti Aktiengesellschaft, Schaan (LI)

(21) Appl. No.: 12/968,090

(22) Filed: Dec. 14, 2010

(30) Foreign Application Priority Data
Dec. 15, 2009 (DE) 10 2009 054 652.9

(51) Int. Cl. B01F 5/06

(52) U.S. Cl. 366/336

(57) ABSTRACT

A static mixer is disclosed. The mixer includes a channel which extends in the main direction and has at least one mixing element arranged therein. The mixing element has structures for dividing, deflecting and/or combining a media stream conveyed through the channel such that at least one dividing structure divides the media stream into at least one first substream and one second substream and such that the first substream and the second substream have different average path lengths from the dividing structure up to the point where they are combined.

This application claims the priority of German Patent Document No. 10 2009 054 652.9, filed Dec. 15, 2009, the disclosure of which is expressly incorporated by reference herein.

### BACKGROUND AND SUMMARY OF THE INVENTION

The invention relates to a static mixer.

European Patent Document No. EP 0 749 776 A1 describes a static mixer having a plurality of identical elements arranged in series, each one having a separating web on the inlet end and a separating web on the outlet end. A symmetrical division and guidance of a media stream in two or more substreams is made possible by means of the separating webs.

The object of the present invention is to provide a static mixer which will have a good tolerance with respect to disturbances in the feedstream of a media stream.

Backmixing is supported by the different path lengths of the two substreams, thereby achieving better compensation of dosing errors and compensating especially well for disturbances in substance quantities occurring in an inlet area of the mixer.

Traditional static mixers have a small reaction volume and therefore a short contact time, in particular in the case of mobile applications, for example, in the field of construction chemistry. Disturbances in substance quantities in the inlet area are therefore hardly compensated at all over the short active mixing zone. In the case of hand-held expeller equipment, for example, the substance quantities are often dosed discontinuously and are conveyed in short surges, often having a volume of a few milliliters, usually a smaller volume than the actual volume of the mixer. Depending on the elasticity of the entire output system, there are in some cases substantial fluctuations in the mixing ratio of components upstream from the mixer. A traditional static mixer compensates for these fluctuations only to a minor extent.

Within the scope of the present invention, a scattering in the average dwell time of the substance quantity in the mixer, which has not previously been used as a criterion, has been used to achieve the greatest possible tolerance with respect to disturbances in particular due to pumping effects at the end where starting materials are added. Through different path lengths, an inventive mixer allows a particularly definite backmixing and thereby a high bandwidth or scattering of the average dwell time in the mixer. Paths of at least two geometrically different lengths are offered to the divided media stream up to a point where they are combined again or brought together. This may also be considered as a time offset of the substreams before they are recombined.

In particular a preferred embodiment of the invention lacks a separating web running over the entire width of the channel to divide the media stream over the entire cross-section, as is customary in the prior art. This prevents a congruity of the paths (rotational symmetry or mirror symmetry), which is typical of almost all static mixers, from the point where they are divided up to the point where they are recombined.

An inventive static mixer is not only optimized for the aforementioned criteria but also fulfills other requirements as needed, such as:
a good micromixing due to a sufficient number of structures for dividing and/or deflecting;
a sufficiently low total hydrodynamic resistance;
a sufficiently small volume surrounded by the mixer, in particular in the case of disposable mixers; and
a simple and inexpensive method of manufacturing.

In a preferred embodiment of the invention, the average path lengths differ by at least approximately 10%, especially preferably by at least approximately 20%. This yields an especially good backmixing.

In an embodiment that is especially simple in design, the mixing element has a base plate, where the base plate has at least one opening. A deflecting element, which has a wall section extending predominantly across the main direction, is arranged downstream from the opening. In this way there may be a division of the substreams in that a first part of the media stream backed up at the deflecting element is diverted through the opening in the base plate and another part is diverted around the deflecting element.

In an especially preferred detail embodiment, this is supported by the fact that the deflecting element also has a wall section extending mainly parallel to the main direction. The wall section extending mainly parallel to the main direction preferably coincides at least partially with the opening, so that the wall section protrudes next to the opening and has an especially efficacious influence on the splitting and deflection of the media stream.

In an effective embodiment that is simple to manufacture, it is provided that the respective deflecting element extends on only one of two opposing sides of the base plate. This allows branching or a partial media stream by means of its passage through the base plate in a simple manner.

In addition, it is possible to provide in general for the base plate to have a right side and a left side across the main direction, such that at least one opening is situated essentially on only one of the halves. Especially preferably two openings are arranged directly one after the other in the main direction on the same half of the base plate. To improve a division into two media streams of different path lengths, a first deflecting structure is arranged immediately downstream from the first of the two openings and extends on one of the two opposing sides of the base plate, such that a second deflecting structure is arranged immediately after the second of the two openings and extends on the other of the two opposing sides.

Depending on requirements, the channel may have an essentially rectangular cross-section, in particular a square cross-section, or may also have an essentially round cross-section, in particular a circular cross-section.

The mixing element is advantageously designed in general as a one-piece component, in particular a cast part of a uniform material. The material of the mixing element and/or channel may be plastic or metal, e.g., aluminum. Being of one piece and of a uniform material may be understood here to mean that the static mixer on the whole has only a one-piece mixing element. However, in an alternative embodiment, a plurality of mixing elements may also be arranged in succession to further improve the mixing effect.

In an advantageous exemplary embodiment, the mixing element can be manufactured by means of a casting mold that is simple to open, in particular a plastic injection mold.

Additional advantages and features of the present invention are derived from the exemplary embodiments described below.

Preferred exemplary embodiments of the invention are described below and are explained in greater detail on the basis of the accompanying drawings.

### BRIEF DESCRIPTION OF THE DRAWINGS

FIG. 1 shows a sectional view of a longitudinal plane through an inventive static mixer.

FIG. 2 shows a three-dimensional view of a mixing element of the mixer from FIG. 1.

FIG. 3 shows a cross-section through the mixer from FIG. 1.

FIG. 4 shows a cross-section through a second exemplary embodiment of the invention.

### DETAILED DESCRIPTION OF THE DRAWINGS

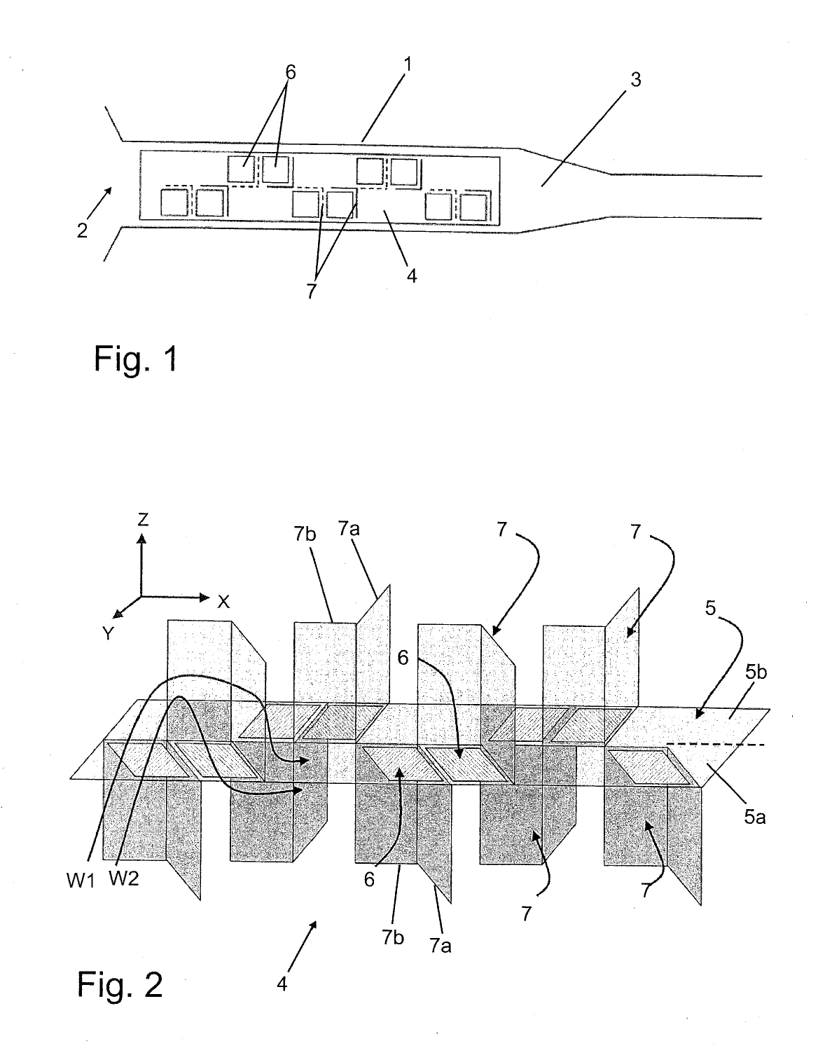

The static mixer in FIG. 1 is designed in the present case as a hand-held disposable mixer from the field of construction chemistry. However, it may also be a reusable design with a different field of use.

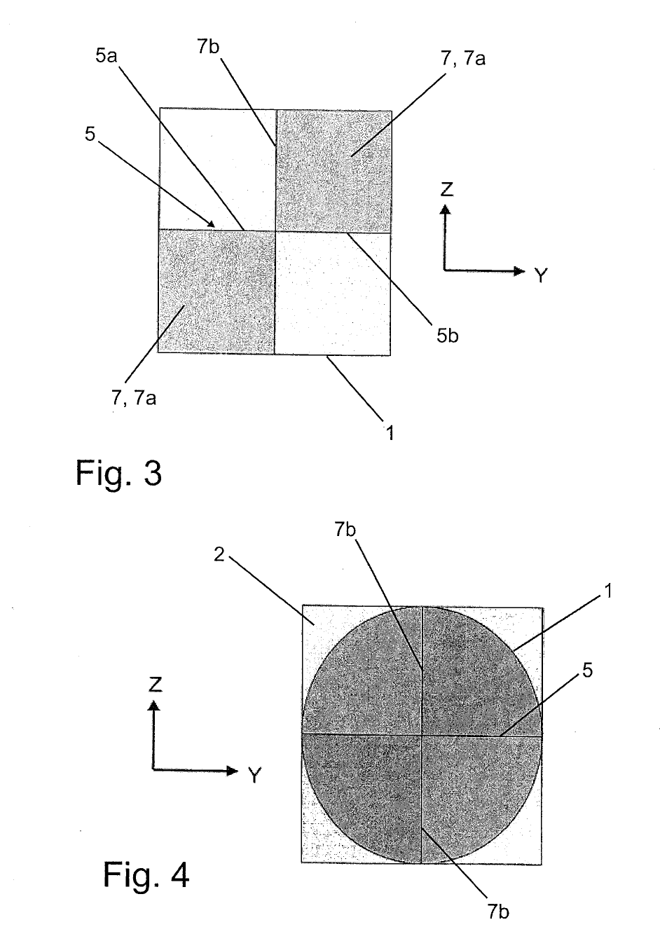

A channel 1 having a rectangular cross-section (see FIG. 3) extends in a main direction X and comprises a mixer volume which is between an inlet area 2 and an outlet area 3 for a media stream conveyed through the channel 1.

A mixing element 4 that is surrounded by the inside wall of the channel 1 is arranged in the mixer volume. The mixer element 4 has a base plate 5, which extends in the longitudinal direction X and in a transverse direction Y and in which a plurality of openings 6 are arranged. The medium can flow through these openings 6 from one side of the base plate to the opposite side of the base plate.

The base plate has a left half 5a and a right half 5b across a central axis of the base plate 5 running in the main direction X. Each opening 6 is arranged on only one of the halves 5a, 5b. There is no opening next to one of the openings 6 in the transverse direction Y.

The openings in the present case have a square extent, which is uniform in all directions. Two of the openings 6 are arranged directly one after the other in the main direction.

A deflecting structure 7, starting from the base plate 5, extends from each of the openings 6 perpendicular to the base plate and on only one of the two sides of the base plate.

The deflecting structures 7 of two openings 6, which follow one another directly on the same half 5a, 5b of the base plate extend on opposite sides of the base plate.

Each of the deflecting structures 7 allocated to an opening comprises a wall section 7a, which extends in the transverse direction and is located directly downstream from the opening 6. Furthermore, the deflecting structure has a wall section 7b, which extends parallel to the main direction in the base plate on the central axis and at least partially coincides with the opening 6.

The present invention functions as follows.

A stream of a pasty or viscous medium is conveyed under a suitable pressure from the inlet area 2 through the channel 1 to the outflow area 3. In particular the medium may first have two or more strands of different substances that are to be mixed together in the channel.

The media stream is dammed up on one of the halves 5a, 5b by a deflecting element 7. A first substream is then diverted through the opening allocated to the deflecting element 7 onto the other side of the base plate 5. The remaining substream runs around the wall section 7b, which is parallel to the main direction, and then is diverted on the other half of the same side of the base plate 5, being returned back to the original half after the deflecting structure 7.

FIG. 2 shows as an example two paths W1, W2 of a media stream which, before being divided, flows first through a first one of two openings 6 directly behind one another, whereupon it is diverted to a deflecting structure that is situated downstream from the opening 6. On the other side of the base plate, which is at the top in FIG. 2, the media stream is then divided into two substreams as described above. The opening 6 and its deflecting structure 7 therefore together form a structure which splits the media stream.

The first substream W1 passes around the deflecting structure 7, which extends on the upper side. The second substream W2 passes again through the base plate on its lower side by passing through the opening 6, which follows directly.

In the remaining course, which is not shown here, the substreams are brought together again to at a partial extent at an opening 6. The substreams have obviously traveled along paths W1, W2 of different lengths.

The openings and deflecting structures are of such dimensions that they are divided into two substreams of at least approximately uniform size. A certain imbalance in this division may be desired because of the different path lengths.

FIG. 3 shows a schematic cross-section through the channel 1, which is square in shape. It can be seen here that the static mixer of this exemplary embodiment is divided into four sectors in the cross-section, these sectors being formed by the separation into an upper side and a lower side as well as a left half and a right half of the base plate 5.

FIG. 4 shows a modification of the example from FIG. 1 to FIG. 3, in which the channel has a circular cross-section. The channel 1 may also have a different cross-sectional shape. In any case the deflecting structures are in flush contact with the channel wall to prevent the medium from being diverted along the channel wall.

The base plate 5 need not form a precise plane, as shown in the examples, but instead may also run with a slight curve or a helical path or the like.

It is self-evident that the invention is not limited to the precise shapes of the elements according to the preceding exemplary embodiments. In particular the walls 7a, 7b of the deflecting structures need not run in a straight line or stand at a right angle to one another. A flowing curved shape or other angles are also possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A static mixer, comprising:
a channel defined by the mixer which extends in a main direction;
a mixing element arranged within the channel, wherein the mixing element includes:
structures for dividing a media stream conveyed through the channel, wherein at least one of the dividing structures divides the media stream into a first substream and a second substream;
wherein the first substream and the second substream have different average path lengths from the at least one of the dividing structures to a point in the channel where the first and second substreams are combined.

2. The static mixer according to claim 1, wherein the average path lengths differ by at least approximately 10%.

3. The static mixer according to claim 1, wherein the mixing element includes a base plate, wherein the base plate defines an opening that comprises at least one of the dividing structures, and wherein the base plate is flat and/or is aligned parallel to the main direction.

4. The static mixer according to claim 3, wherein a deflecting element comprises at least one of the dividing structures, wherein the deflecting element has a first wall section extending across the main direction, and wherein the deflecting element is arranged in the channel downstream from the opening in a flow direction.

5. The static mixer according to claim 4, wherein the deflecting element has a second wall section extending parallel to the main direction.

6. The static mixer according to claim 5, wherein the second wall section coincides at least partially with the opening.

7. The static mixer according to claim 4, wherein the deflecting element extends only on one side of the base plate.

8. The static mixer according to claim 3, wherein the base plate has a left half and a right half and wherein the opening is located on only the left half or the right half of the base plate.

9. The static mixer according to claim 8, wherein the base plate defines a second opening and wherein the openings are arranged one after the other in the main direction on a same half of the base plate.

10. The static mixer according to claim 9:
wherein a second deflecting element comprises at least one of the dividing structures;
wherein the deflecting structure is arranged directly after the opening and extends on a first side of the base plate;
and wherein the second deflecting structure is arranged directly after the second opening and extends on a second side of the base plate, wherein the first side is opposite from the second side.

11. The static mixer according to claim 1, wherein the channel has a rectangular or square cross-section.

12. The static mixer according to claim 1, wherein the channel has a round or circular cross-section.

13. The static mixer according to claim 1, wherein the mixing element is a one-piece component.

14. The static mixer according to claim 13, wherein the mixing element is formed in a plastic injection mold.

15. A method for mixing a media stream, comprising the steps of:
dividing the media stream at a first end of a channel defined by a mixer into a first substream and a second substream by a mixing element arranged within the channel such that first substream and the second substream have different average path lengths through the channel; and
combining the first and second substreams at a second end of the channel.
